(19) United States
(12) Patent Application Publication
(10) Pub. No.: US 2006/0220812 A1
(43) Pub. Date: Oct. 5, 2006

(54) Wheel unit for motor vehicle tyre pressure monitoring device

(75) Inventor: Dominique Luce, Bordes de Rivlere (FR)

Correspondence Address: YOUNG & THOMPSON, 745 SOUTH 23RD STREET, 2ND FLOOR, ARLINGTON, VA, 22202, US

(73) Assignee: Siemens vdo Automotive, Toulouse Cedex 1 (FR)

(21) Appl. No.: 10/559,185

(22) PCT Filed: May 17, 2004
(86) PCT No.: PCT/EP04/05262

§ 371 Date: Apr. 3, 2006

Related U.S. Application Data
(60) Provisional application No. 60/474,988, filed on Jun. 2, 2003.

(51) Int. Cl. B60Q 1/00

(52) U.S. Cl. 340/442; 340/449; 73/146

(57) ABSTRACT

A wheel unit (10), for a motor vehicle tire pressure monitoring device, the wheel unit being embodied for fitment to a rim (16) of a motor vehicle wheel. The unit includes a support (11) and an electronics housing (12), incorporating at least a pressure and/or temperature sensor, electrical components necessary for processing a signal coming from said sensors and a device for transmission of the processed signal to a central unit, housed in the vehicle, the unit being characterised in that the housing (12) is mounted on the support (11), itself fixed to the rim (16) by a layer of glue (15) and the support includes a central housing element (20, 13) to retain at least a central part of the housing in the support.

The present invention relates to a wheel unit for a device for monitoring the pressure of motor vehicle tires.

More specifically, this wheel unit is intended to be fastened by bonding or strapping to each of the rims of the vehicle wheels and inside the tire.

It is already known practice to equip the wheels of motor vehicles with a wheel unit intended to monitor the pressure of the tires. These wheel units are placed inside each tire and comprise suitable sensors (pressure sensor, temperature sensor, acceleration sensor, etc.). When an abnormal pressure is detected, an alarm message is transmitted to the driver.

These wheel units generally consist of a support which is fastened to the rim and firmly retains an electronic box containing all the components required for measurement (pressure and temperature sensors, etc.), for processing the measured signal and for then transmitting it to a central unit situated remotely in the vehicle. The connection between the wheel unit and the central unit is generally produced by radiofrequency (RF) waves.

When the vehicle is moving, each wheel unit is subjected to a centrifugal force proportional to the speed of rotation of the wheel on which it is mounted. Thus, the fastening of the wheel unit to the rim must be calculated to withstand such a centrifugal force without the risk of disconnection between the wheel unit and the rim.

For this purpose it is possible to retain the box in a support, itself bonded to the rim. The box is then retained at its periphery, for example by means of elastic interlocking.

However, retaining the box at its periphery in this way generates forces (due to the rotation of the wheel) in the adhesive layer binding the support to the rim, these forces being distributed over the periphery of the support and tending to cause stripping of the adhesive layer by peeling.

This stress results in the “peeling” of the adhesive layer, which separates from the rim in a manner similar to unwinding a roll of adhesive paper. The fact is that when an adhesive layer works in peel, the force required to cause stripping is small. The centrifugal force exerted on the periphery of the support need therefore not be large for the peeling phenomenon to occur.

Sub-retention of the box at its peripheral region in its support therefore leads to increased risks of deterioration of the adhesive layer (by peeling) even when the wheel is rotating at a low speed.

The aim of the present invention is to overcome this disadvantage by preventing the adhesive layer from working in peel while at the same time reliably fastening the support to the rim.

To this end, the present invention relates to a wheel unit for a device for monitoring the pressure of motor vehicle tires, said wheel unit being designed to be fastened by bonding to a rim of a motor vehicle wheel, said unit comprising:
a support, and
an electronic box mounted in the support and combining:
   at least one pressure and/or temperature sensor,
   electronic components required for processing a signal from these sensors, and
   a device for transmitting the processed signal to a central unit provided in the vehicle,
      said unit being characterized in that said support comprises a central retention means designed to firmly retain at least a central portion of the box in the support.

By fastening the central portion of the box to the support, the adhesive layer interposed between the support and the rim no longer works in peel but in tension and shear.

What happens is that the centrifugal force generated by the rotation of the wheel is exerted at the center of the support in the form of a tension between the box and its support at the location of their connection means, therefore at the center. The adhesive layer provided between the support and the rim is therefore subjected to a central tensile force. This adhesive layer therefore works in tension and in shear. Consequently, the force required to break the bonded connection between the support and the rim is significantly greater than that which makes it possible to break an adhesive layer working in peel.

Thus, by judiciously placing the region of connection between the support and the box at the center of the box (which is the heaviest element of the assembly and therefore the element to which the centrifugal force is preferentially applied), the work in tension and shear of the adhesive layer is promoted, making said layer stronger.

According to a first embodiment, the central retention means for the box is advantageously provided by a central stud passing right through the box and secured thereto at the upper face of the box by the elastic interlocking of a clasp, pin, nut or any similar means. The central stud for its part is fastened to the rim by riveting or screwing or by a nut or forms an integral part of the rim.

According to a second embodiment, the central retention means for the box is provided by the cooperation between a clasp and two central lugs formed on the support.

Advantageously, the clasp is placed on the box by sliding in a pair of grooves formed in the box and by elastic interlocking with the lugs. The means of connection between the box and the support therefore consists of this clasp placed, according to the invention, at the center of the box. Consequently, in this second embodiment too, the adhesive layer connecting the support to the rim works in tension and shear and not in peel. The strength of the rim/support connection is thus increased.

To facilitate the positioning of the support with respect to the rim, the support is provided with a plurality of prepositioning regions enabling the support to be lightly and temporarily bonded to the rim before it is finally bonded by means of an adhesive layer having high adhesive strength.

Advantageously, the support is provided with damping means for opposing the vibrations transmitted to the box by the wheel. These damping means also serve as a centering guide for positioning the box with respect to the support.

To ensure that the support is correctly held in place on the rim even if the adhesive layer is broken, an auxiliary retaining band is fitted to the support and clamps it firmly against the rim.

Moreover, other subjects, features and advantages of the present invention will become apparent from the description which follows, by way of nonlimiting example, with reference to the appended drawings, in which:

FIG. 1 is a schematic perspective view representing a support 11 according to a first embodiment of the invention,

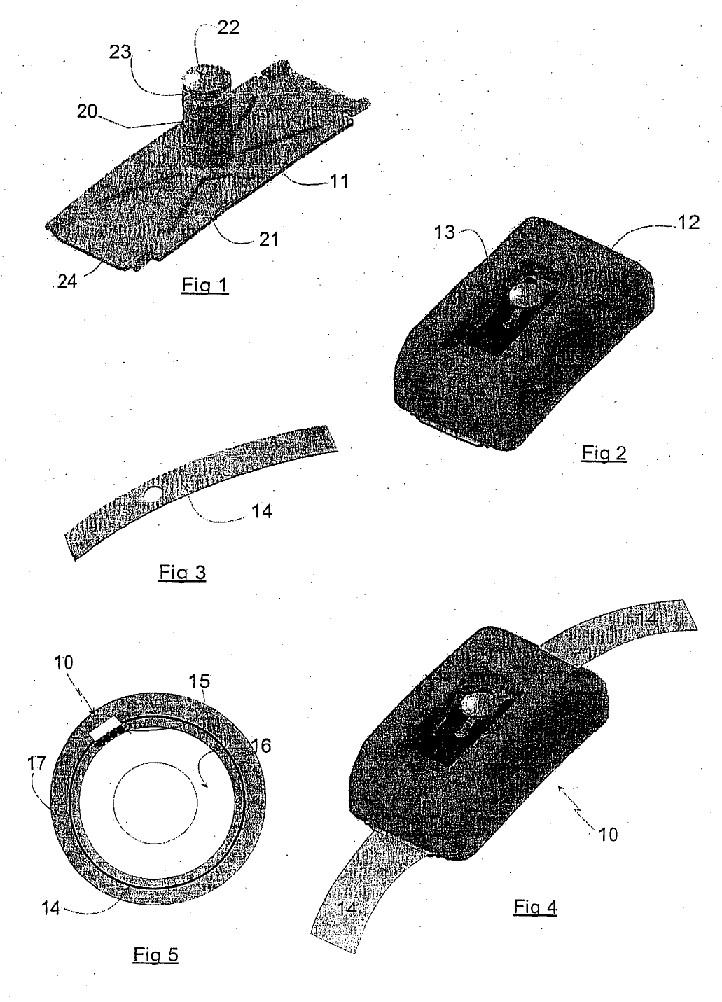

FIG. 2 is a schematic perspective view showing an electronic box 12 mounted on a support 11 according to a first embodiment of the invention,

FIG. 3 is a schematic perspective view showing an auxiliary retaining band 14,

FIG. 4 is a schematic perspective view illustrating a wheel unit 10 according to a first embodiment of the invention composed of a box 12 mounted on a support 11 and held in position by a clasp 13,

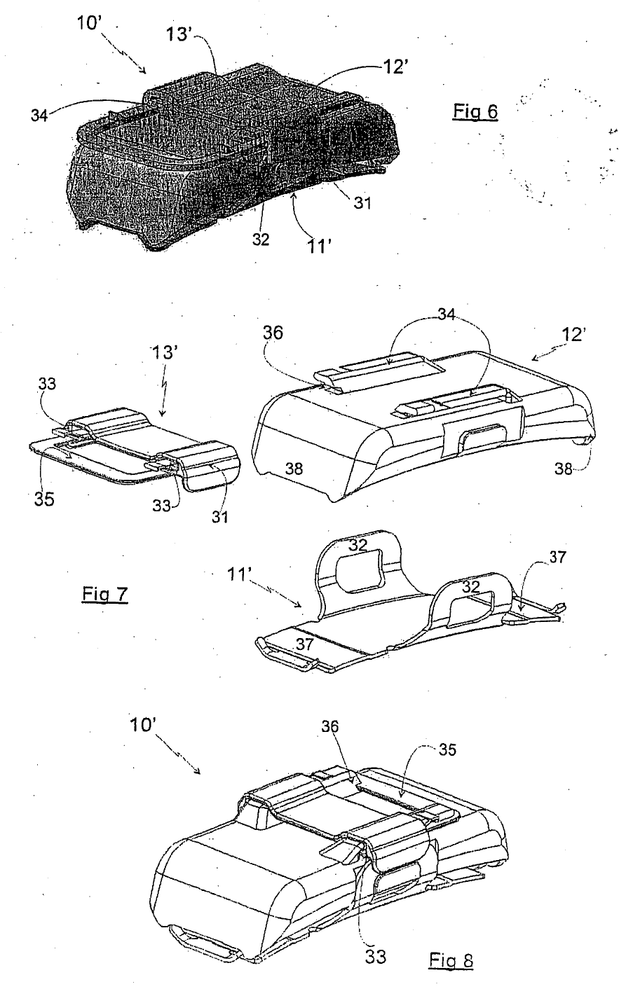

FIG. 5 is a schematic sectional view showing the assembly of a wheel unit according to the invention on a rim of a motor vehicle,

FIG. 6 is a schematic perspective view of a wheel unit 10′ according to a second embodiment of the invention,

FIG. 7 is a schematic perspective view illustrating the assembly of the support 11′, the clasp 13′ and the box 12′ according to the second embodiment of the invention, and

FIG. 8 is a schematic perspective view illustrating the wheel unit 10′ of FIG. 7 in its assembled state.

According to the embodiment illustrated in FIGS. 1 to 4, the wheel unit 10 according to the present invention is composed of:
a support 11 (FIG. 1),
an electronic box 12 (FIG. 2),
a fastening clasp 13 (FIG. 2), and
an auxiliary retaining band 14 (FIG. 3).

All these elements are presented in their assembled form in FIG. 4.

The wheel unit according to the present invention (regardless of its embodiment) is intended to be bonded 15 (FIG. 5) to a motor vehicle wheel rim 16.

The wheel unit is placed in the chamber of a tire 17. It comprises an electronic box 12 provided with at least one pressure sensor. This sensor measures the pressure prevailing in the tire chamber. Other sensors (temperature sensor, acceleration sensor, etc.) may also be present in the box. Electronic components are also placed in the box for the purpose of picking up and processing the signals from the sensors. Once processed, these signals are sent by radiofrequency signal to a central unit (not shown) situated in the vehicle cabin. This central unit is connected to a display means (situated in the vehicle) transmitting information and/or alert messages to the driver concerning, in particular, the pressure prevailing in his tires. The information or alert messages may also be transmitted to the driver by way of an audible signal, tactile signal, etc.

To fasten the wheel unit 10 to the rim 16, the support 11 (FIG. 1) is bonded 15 to the rim. The adhesive used is of the cyanoacrylate or epoxy type. This adhesive has high adhesive strength. The support 11 is made of steel (or similar material) and has a central stud 20 (central retention means) of generally cylindrical shape. This central stud is fastened by any suitable means to the support. A first end 21 of this stud is welded (or the like) to the support and its second end 22 bears an annular groove 23. Reinforcing ribs 24 are formed on the base of the support.

It should be noted that the central stud may also be fixedly attached to the rim either by forming an integral part thereof or by being riveted (or the like) through the rim. In that case, the support 11 is drilled to allow the stud to pass through the support.

The box 12 has a generally parallelepipedal shape. It has a through orifice at its center. To fasten the box to the support, the central stud 20 of the support is inserted into the through orifice (not shown) of the box. To keep the box firmly in place on the central stud, a clasp 13 is inserted into the annular groove 23 of the central stud. This clasp tightly encloses (see FIGS. 2 and 4) the central stud, thus locking the box on the support. This clasp also has a spring action enabling the box to be pressed against the support.

Thus mounted, the wheel unit is therefore bonded against the rim by means of the adhesive layer 15 situated between the rim and the support.

If the bonded connection between the support and the rim should deteriorate, and in order to avoid a situation in which the wheel unit moves freely inside a rotating tire (which would be dangerous), a retaining band 14 is placed onto the central stud 22 (before fitting the box). This band completely encircles the rim (see FIG. 5). The two ends of this band are connected by clamping, for example.

If the bonded connection is broken, this retaining band therefore makes it possible to ensure that the wheel unit is still fastened to the rim.

The support is provided with a passage guide (not shown) known per se for the retaining band 14.

To assist in prepositioning the support on the rim, the underside of the support (not visible in the drawings) is provided with at least one prepositioning region coated with an adhesive whose adhesive strength is weak and/or temporary. This makes it possible to keep the support in place while the adhesive layer 15 is drying. Once dried, this adhesive 15 alone provides the connection between the support and the rim.

In a preferred embodiment, the support is provided with two regions for prepositioning the support with respect to the rim. These regions are preferably arranged one on either side of a central bonding region 15 having high adhesive strength.

It should be noted that the adhesive layer 15 works, when the wheel is rotated, in tension and shear. Consequently, the strength of the support/rim connection is increased. This is because the force required to break an adhesive layer working in tension and shear is considerably greater than that required to break an adhesive layer working in peel. Thus, when the wheel is rotated, the centrifugal force due to the weight of the box is applied to the central stud 20 and therefore to the center of the adhesive layer (which thus works in tension).

Thus, by judicially positioning the box/support connection at the center of the box, the work of the adhesive layer in tension and shear is promoted and the strength of the bonded connection is therefore improved.

According to a second embodiment of the invention, the central retention means is provided in the form of a clasp 13′ cooperating with two central lugs 32 of the support (FIGS. 6 to 8).

This clasp 13′ is situated at the center of the box and has two lateral wings 31 interlocking elastically with the two central lugs 32 formed on the support 11′. To completely secure the clasp 13′ on the box, the clasp is provided with two lateral runners 33 (FIG. 7) designed to slide in two grooves 34 formed in the upper side of the box 12′. When the runners 33 of the clasp are engaged in the grooves 34 in the box, the two components are prevented from moving translationally with respect to one another by means of a crossbar 35 which is integral with the clasp and becomes locked in stops 36 of the box (FIGS. 7 and 8). Thus locked, the clasp is fixedly attached to the box by virtue of the cooperation between the runners and the grooves and is prevented from moving translationally with respect to the box due to the cooperation between the crossbar 35 and the stops 36.

In addition, the clasp is fixedly attached to the support by its wings 31, cooperating with the lugs 32 of the support. The elements constituting the wheel unit are therefore immobilized with respect to one another and the connection between the box (the heaviest element on which the centrifugal force is predominantly exerted) and the support is a central connection. The adhesive layer connecting the support 11′ to the rim (not shown) therefore works in tension and shear and not in peel.

It should be noted that the support 11′ has spring-forming end regions 37 constituting a means for damping any vibrations of the free ends 38 of the box when the wheel is rotated. These damping means also serve as guide and centering means for positioning the box with respect to the support, the reason for this being to prevent the adhesive layer 15 working at all in peel.

In all the embodiments represented, the ends 38 of the box are left free in the support, again to prevent the adhesive layer 15 working at all in peel. Likewise, the passage guide for the retaining band 14 is present on each support (according to the first and the second embodiment) or box. Specifically, this passage guide may be provided by means of a simple channel produced in the box. In that case, the retaining band clamps the support and the box onto the rim.

Of course, the invention is not restricted to the above-described embodiments but covers any variant within the scope of a person skilled in the art.

1-13. (canceled)

14. A wheel unit (10, 10′) for a device for monitoring the pressure of motor vehicle tires, said wheel unit being designed to be fastened to a rim (16) of a motor vehicle wheel, said unit comprising:
a support (11, 11′), and
an electronic box (12, 12′) combining:
at least one pressure and/or temperature sensor,
electronic components required for processing a signal from these sensors, and
a device for transmitting the processed signal to a central unit provided in the vehicle,
said unit being characterized in that the box (12, 12′) is mounted on the support (11, 11′), itself secured to the rim (16) by means of an adhesive layer (15), and in that said support comprises a central retention means (13, 20; 13′, 32) designed to retain at least a central portion of the box in the support.

15. The unit as claimed in claim 14, characterized in that the box additionally comprises lateral ends (38) left free in the support.

16. The unit as claimed in claim 14, characterized in that it is designed to withstand a central centrifugal force acting through tension and shear on the adhesive layer (15) without a peeling phenomenon being experienced by this adhesive layer.

17. The unit as claimed in claim 14, characterized in that the central retention means cooperates with a clasp (13′) for retaining the box in the support.

18. The unit as claimed in claim 17, characterized in that the central retention means (13′) comprises a pair of lugs (32) cooperating with said clasp.

19. The unit as claimed in claim 17, characterized in that the clasp (13′) is put in place by sliding in a pair of grooves (34) formed in the box and by elastic interlocking with the lugs (32) of the support.

20. The unit as claimed in claim 14, characterized in that the support (11, 11′) is provided with a bonding region (15) for bonding to the rim and with two regions for prepositioning the support with respect to the rim, said prepositioning regions being arranged on either side of the bonding region.

21. The unit as claimed in claim 14, characterized in that it comprises a damping means (37) for opposing the vibrations transmitted to the box by the wheel, said damping means also forming a centering guide designed for positioning the box with respect to the support.

22. The unit as claimed in claim 17, characterized in that the clasp (13′) has an elasticity designed to press the box against the support.

23. The unit as claimed in claim 17, characterized in that the central retention means is a stud (20) passing right through the center of the box.

24. The unit as claimed in claim 23, characterized in that the stud is provided with an annular groove (23) for fitting a clasp (13).

25. The unit as claimed in claim 22, characterized in that the central stud (20) is fastened by riveting through the rim (16) and keeps the support (11) in place.

26. The unit as claimed in claim 14, characterized in that it additionally comprises a passage guide for an auxiliary retaining band (14) which enables the support and/or the box to be fastened to the rim if the bonded connection between the support and the rim is broken.
